(19) United States
(12) Patent Application Publication
(10) Pub. No.: US 2008/0014433 A1
(43) Pub. Date: Jan. 17, 2008

(54) METHOD FOR REMOVING VOLATILE ORGANIC COMPOUNDS (VOCs) FROM AN AIR STREAM

(75) Inventors: Baron V. Adams, Oregon City, OR (US); James T. Boswell, Montgomery, TX (US); Karl W. Mundorff, Portland, OR (US); Paul C. John, Beaverton, OR (US)

Correspondence Address: SMITH-HILL AND BEDELL, P.C., 16100 NW CORNELL ROAD, SUITE 220, BEAVERTON, OR, 97006, US

(73) Assignee: BIO-REACTION INDUSTRIES, LLC, Tualatin, OR (US)

(21) Appl. No.: 11/775,440

(22) Filed: Jul. 10, 2007

Related U.S. Application Data
(60) Provisional application No. 60/807,163, filed on Jul. 12, 2006.
(60) Provisional application No. 60/869,623, filed on Dec. 12, 2006.

(51) Int. Cl. B32B 5/16; C02F 3/02

(52) U.S. Cl. 428/326; 156/299; 210/620; 428/528

(57) ABSTRACT

A composite wood product is manufactured by heating and pressing wood materials in contact with a mixture of resin and urea. Gases that evolve from the heating and pressing of the wood materials, resin and urea are collected and are passed through a biological oxidation system to remove volatile organic compounds.

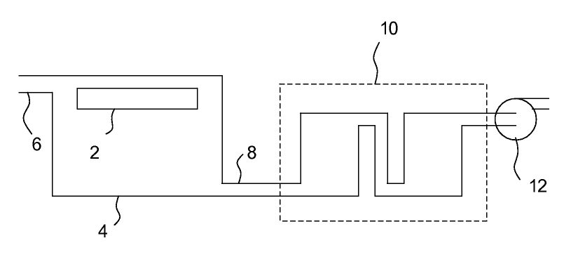

### CROSS-REFERENCE TO RELATED APPLICATION

This application claims benefit of U.S. Provisional Application No. 60/807,163 filed Jul. 12, 2006 and U.S. Provisional Application No. 60/869,623 filed Dec. 12, 2006, the entire disclosure of each of which is hereby incorporated by reference herein for all purposes.

### BACKGROUND OF THE INVENTION

This invention relates to a method for removing volatile organic compounds (VOCs) from an air stream.

Composite wood products, such as oriented strand board, particle board, fiber board and plywood, are made from relatively small pieces of raw wood materials. The raw wood materials may be in many different forms depending on the composite wood product that is being made. For example, in the case of plywood, the raw wood materials are thin sheets of wood veneer that may be a meter or more long and a meter or more wide but only about 3-6 mm thick whereas in the case of particle board, the raw wood materials may be quite small particles, no larger than 4-5 mm in any dimension.

In manufacture of a composite wood product, a mat containing raw wood materials and other ingredients including resins and wax is formed and is placed in a press in which the mat is compressed at an elevated temperature (typically ranging from 130° C. to 250° C.). The wood materials are bonded together by the resin to create a monolithic product, such as a board or panel.

Resins commonly used in manufacture of composite wood products include phenol formaldehyde (P-F), urea formaldehyde (U-F) and/or medium density isocyanates (MDI). In the manufacture of composite wood products the proportion of resin may be in the range from about 2 wt % to about 5 wt % of the component materials comprising the wood mat that will be pressed into the panel/board product.

Because the resins are expensive, it is known to include a resin extender in the mat ingredients. The extender (typically sodium hydroxide) is used to adjust the pH of the resin mixture, and replaces some of the resin and allows a smaller proportion of resin to be used in forming the composite wood product.

The heating and pressing of the raw wood materials (containing approximately 3 wt % to 9 wt % moisture) with the resin and other ingredients results in the evolution of steam and other gases, including volatile organic compounds (VOCs).

It is generally considered that the VOCs should be controlled to a specific emission amount (mass per unit time) before discharge to the atmosphere. In addition, a removal efficiency (percentage) may be specified. Accordingly, it is conventional to capture the gases emitted during heating and pressing of the wood materials and resin and entrain the captured gases in a press air stream that passes through a VOC abatement device. Thus, the press is contained in an enclosure to prevent escape of the gases into the atmosphere. The enclosure has an air inlet, through which air can enter the enclosure from the atmosphere, and an air outlet that is ducted to the VOC abatement device.

Emission standards require that a specific emission limit be met before the air stream is discharged to the atmosphere.

One type of VOC abatement device that is currently in use is the thermal oxidizer, which removes VOCs in the airstream by heating the airstream and combusting the VOCs in excess oxygen to form primarily CO₂ and H₂O. VOC removal effectiveness for thermal oxidizers ranges from approximately 90 to 98 wt %.

The thermal oxidizer is subject to disadvantage as a VOC abatement device because it operates at high temperature and unless the air stream contains an unusually high concentration of VOCs, a large amount of energy in the form of supplemental fuel (natural gas or fuel oil) is required to sustain the combustion temperature necessary for the appropriate VOC abatement (typically above 800° C. for thermal oxidation). In addition, the combustion process in the thermal oxidizer often produces CO and NOₓ.

Biological oxidation systems are attractive for removal of VOCs from an air stream because they operate at much lower temperatures (18° C. to 45° C.) than thermal oxidizers and therefore consume much less energy because no additional fuel is necessary for combustion. However, biological oxidation systems generally operate better with water soluble (hydrophilic) VOCs, such as methanol and formaldehyde, than with the VOCs produced in manufacture of composite wood products, which typically include a relatively large proportion of low solubility (hydrophobic) VOCs such as alpha-pinene, which are not easily collected and metabolized by the organisms colonizing the biological oxidation system. It has been found that under normal conditions, a biological oxidation system will remove between 45 and 75 wt % of the VOCs in an air stream emitted during manufacture of composite wood products.

### SUMMARY OF THE INVENTION

According to a first aspect of the present invention there is provided a method of manufacturing a composite wood product, comprising heating and pressing wood materials in contact with a mixture of resin and urea, collecting gases that evolve from the heating and pressing of the wood materials, resin and urea, and passing the gases through a biological oxidation system to remove volatile organic compounds.

According to a second aspect of the present invention there is provided a method of processing a gas stream containing low solubility VOCs comprising adding ammonium ions to the gas stream, wherein the ammonium ions combine with the low solubility VOCs to produce higher solubility compounds, and supplying the gas stream to a biological oxidation system.

### BRIEF DESCRIPTION OF THE DRAWINGS

For a better understanding of the invention, and to show how the same may be carried into effect, reference will now be made, by way of example, to the accompanying drawings, the single FIGURE of which illustrates schematically apparatus employed in carrying out a method embodying the invention for manufacture of a composite wood product.

### DETAILED DESCRIPTION

In the following description, the term “high solubility compound” means a compound, such as methanol or formaldehyde, that is readily soluble in water, whereas the term “low solubility compound” means a compound, such as alpha-pinene, that is substantially less soluble in water than a high solubility compound.

It has been discovered that under some circumstances, the proportion of low solubility VOCs in the press emission air stream from manufacture of composite wood products can be reduced. In particular, it has been found that urea and alpha-pinene react at temperatures substantially below that required for thermal oxidation, resulting in the conversion of the alpha-pinene to a more water-soluble compound(s) that is (are) more easily biodegradable. The mechanism by which this occurs is not fully understood, but it is believed that the urea thermally decomposes to produce ammonium ions which react with the alpha-pinene by insertion into the double bond thereby forming an ammoniacal compound that is of higher solubility in water and consequently is more easily biodegradable. A biological oxidation system then becomes more attractive for processing the press emission air streams associated with the manufacture of composite wood products. In particular, it has been found that when urea is added to the mix of resin, wood materials and other additives employed in the manufacture of composite wood products, the proportion of low solubility VOCs in the press emission air stream is substantially reduced compared to the case when no urea is included in the mix, and a biological oxidation system is then able to remove between 90 and 95 wt % of VOCs from the air stream.

Referring to the FIGURE, a mat containing raw wood materials, a phenol formaldehyde (P-F) resin, wax and other ingredients, including 2-6 wt % urea (based on the weight of resin and wax), preferably approximately 3 wt % urea, is placed in a press 2. The press 2 is located in an enclosure 4 and is provided with means (not separately shown) for both compressing and heating the mat. The enclosure 4 has an air inlet 6 and also has an air outlet 8, which is connected by ducting to a biological oxidation system 10, such as a two-stage system including a tricking filter stage as described in U.S. Pat. No. 6,790,653. A blower 12 having its suction side connected to the outlet of the biological oxidation system induces a flow of air through the enclosure 4 and the biological oxidation system 10 so that the press emission air stream from the press passes to the biological oxidation system. The biological oxidation system removed between 90 and 95 wt % of VOCs from the press emission air stream.

The precise mechanism by which the addition of urea to the raw material and resin mix results in a press emission air stream from which the biological oxidation system was able to remove a greater than expected proportion of VOCs is not fully understood, but one possible explanation is that heating in the press results in thermal decomposition of the urea to produce ammonium ions that react with the alpha-pinene in the VOCs that are released during heating and pressing to create ammoniacal compounds, which are more water soluble than alpha-pinene and are readily metabolized by the organisms that populate the biological oxidation system.

Adding urea to the mixture of wood materials and resin provides pH adjustment and has a second advantage in that it may also reduce the amount of resin required to form a commercially acceptable composite wood product. Thus, the inexpensive urea functions as an extender for the expensive phenol formaldehyde resin. The urea could serve to replace as much as 10% of the resin (subject to other constraints on the amount of urea). For example, if 100 mass units of P-F resin would normally be employed in the manufacture of a particular product unit, by including 10 mass units of urea it is possible to reduce the quantity of P-F resin to approximately 90-95 mass units.

A comparative test was conducted in which the conditions were the same as the method described with reference to the FIGURE except that the ingredients of the mat did not include urea and accordingly the proportion of P-F resin was that which is employed conventionally and is rather higher than that used in the method described with reference to the drawing. The composite wood product produced by the method described with reference to the FIGURE was of comparable quality to that produced by the method of the comparative test. In the comparative test, the biological oxidation system removed between 45 and 75 wt % of the VOCs in the press emission air stream.

The amount of urea that is added to the mix of wood materials may be as much as 10% of the weight of the resin. Including more than 10 wt % urea may increase the proportion of VOCs removed by the biological filter system, but would not be expected to reduce the amount of P-F resin needed to produce a composite wood product of commercial quality.

The invention is not limited to use with P-F resin but is applicable to other resins, such as urea formaldehyde and MUPF (melamine urea phenol formaldehyde) resins.

The present invention may also be applicable to removal of VOCs from gas streams other than those emitted during manufacture of composite wood products, such as gas streams produced by the paint, coating, petrochemical and chemical industries and which may contain other low solubility VOCs, such as the BTEX compounds (benzene, toluene, ethylbenzene and xylenes) and various other low solubility solvents.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of the claims beyond the literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A method of manufacturing a composite wood product, comprising heating and pressing wood materials in contact with a mixture of resin and urea, collecting gases that evolve from the heating and pressing of the wood materials, resin and urea, and passing the gases through a biological oxidation system to remove volatile organic compounds.

2. A method according to claim 1, wherein the resin comprises one or more of phenol formaldehyde, urea formaldehyde and melamine urea phenol formaldehyde resins.

3. A method according to claim 1, wherein the resin is a phenol formaldehyde resin and the urea is present in the proportion of approximately 10 wt % of the resin.

4. A method of processing a gas stream containing low solubility VOCs comprising adding ammonium ions to the gas stream, wherein the ammonium ions combine with the low solubility VOCs to produce higher solubility compounds, and supplying the gas stream to a biological oxidation system.
